(19) United States
(12) Patent Application Publication
(10) Pub. No.: US 2006/0268477 A1
(43) Pub. Date: Nov. 30, 2006

(54) Apparatus for ESD protection

(76) Inventors: Benjamin Van Camp, Brugge (BE); Bart Keppens, Gistel (BE)

Correspondence Address: LOWENSTEIN SANDLER P.C., 65 LIVINGSTON AVENUE, ROSELAND, NJ, 07068, US

(21) Appl. No.: 11/229,025

(22) Filed: Sep. 16, 2005

Related U.S. Application Data
(60) Provisional application No. 60/610,294, filed on Sep. 16, 2004.

(51) Int. Cl. H02H 9/00

(52) U.S. Cl. 361/56

(57) ABSTRACT

Apparatus for ESD circuit protection including a trigger subcircuit coupled between a first voltage reference potential and second voltage reference potential and an ESD shunt subcircuit coupled to the trigger subcircuit between a circuit device to be ESD-protected and the second voltage reference potential. The ESD shunt subcircuit is adapted for connection by a pad of an integrated circuit (IC) connection. The ESD shunt subcircuit is a silicon-controlled rectifier (SCR) that has an anode connected to the circuit device to be ESD-protected and a cathode connected to the second voltage reference potential. The trigger subcircuit is either an RC-triggered PMOS or a GGNMOS and series connected resistor.

This application claims benefit of U.S. provisional patent application Ser. No. 60/610,294, filed Sep. 16, 2004, which is incorporated by reference.

### BACKGROUND OF THE INVENTION

1. Field of the Invention

This invention generally relates to the field of electrostatic discharge (ESD) protection circuitry and, more specifically, improvements for silicon controlled rectifier (SCR) structures in the protection circuitry of an integrated circuit (IC).

2. Description of the Related Art

Integrated circuits (ICs) and other semiconductor devices are extremely sensitive to the high voltages that may be generated by contact with an ESD event. As such, electrostatic discharge (ESD) protection circuitry is essential for integrated circuits. An ESD event commonly results from the discharge of a high voltage potential (typically, several kilovolts) and leads to pulses of high current (several amperes) of a short duration (typically, 100 nanoseconds). An ESD event is generated within an IC, illustratively, by human contact with the leads of the IC or by electrically charged machinery being discharged in other leads of an IC. During installation of integrated circuits into products, these electrostatic discharges may destroy or impair the function of the ICs and thus require expensive repairs on the products, which could have been avoided by providing a mechanism for dissipation of the electrostatic discharge to which the IC may have been subjected.

ESD protection circuitry is typically a “local” device. That is, such protection circuitry is directly connected to a node of a circuit (i.e., semiconductor device or input pin of an IC) that may be susceptible to ESD damage. Such direct connection reduces the voltage at the node during an ESD event by shunting the voltage to, for example, ground. One example of such an arrangement is shown in the schematic circuit diagram of FIG. 1.

An ESD protection circuit 100 is depicted as being coupled from an input pad 110 to ground 112. In this configuration, the circuit 100, when exposed to an ESD event, shunts the event, e.g., a high voltage, from the pad 110 to ground 112; thus, protecting the circuitry within an integrated circuit that requires protection. Such ESD protection circuits are described in commonly assigned U.S. Pat. No. 6,791,122, which is hereby incorporated by reference.

More specifically, the ESD protection circuit 100 comprises a trigger circuit (e.g., nMOS transistor 102) coupled to a protection circuit (e.g., silicon controlled rectifier (SCR) 116. The nMOS transistor 102 has its drain 104 connected to an input pad 110 and its source 106 connected to ground potential 112 through a resistor 114. The gate 108 of the transistor 102 is connected to the source 106 through a resistor 114. The SCR 116 has a first terminal 118 connected to pad 110 and a second terminal 120 connected to ground potential 112. A third terminal 122, the trigger terminal, is connected to the source 106 of the transistor 102. In operation, when an ESD event is “sensed” by the trigger circuit 102, a trigger signal is generated to cause the SCR 116 to begin conducting (i.e., “turn on”). The current path through the SCR 116 shunts the ESD event from the pad to ground.

Unfortunately, there are a number of disadvantages to such a design solution: (1) the ESD protection circuitry 102 creates a “footprint” (i.e., consumes additional area on an integrated circuit proximate each pad) that may not have been considered during the original circuit design, (2) the ESD protection circuitry introduces parasitic capacitance to the pad 110 (connection point between an IC and other circuit devices) and (3) the trigger circuit leaks current from the pad to ground where, in certain ICs, the leakage may interfere with normal operation of the protected circuitry and the overall IC.

Thus, there is a need for an apparatus that is capable of providing ESD protection yet have a minimum impact on available design space and circuit performance.

### SUMMARY OF THE INVENTION

The disadvantages of the prior art are overcome by an apparatus for ESD circuit protection including a trigger subcircuit coupled between a first voltage reference potential and second voltage reference potential, and an ESD shunt subcircuit coupled to the trigger subcircuit and coupled between a circuit device to be ESD-protected and the second voltage reference potential. The ESD shunt subcircuit is coupled to a pad of an integrated circuit (IC) connection. A conductive path couples the trigger subcircuit to the shunt subcircuit to provide an ESD current to the trigger subcircuit. In one embodiment, the ESD shunt subcircuit is a silicon-controlled rectifier (SCR) that has an anode connected to the circuit device to be ESD-protected and a cathode connected to the second voltage reference potential.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a circuit schematic diagram of a typical ESD protection circuit connected to a power pad of an integrated circuit;

FIG. 2 is a block diagram of a ESD protection circuit in accordance with the subject invention;

FIG. 3 is a circuit schematic diagram of a first embodiment of the ESD protection circuit seen in FIG. 2; and

FIG. 4 is a circuit schematic diagram of a second embodiment of the ESD protection circuit seen in FIG. 2.

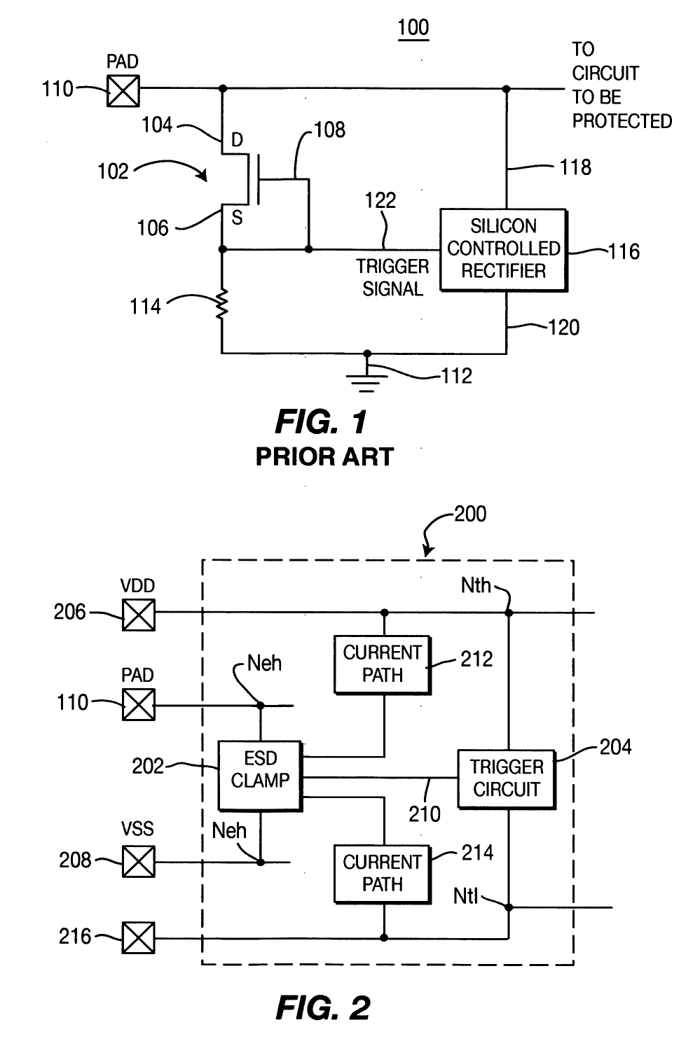

To facilitate understanding, identical reference numerals have been used, wherever possible, to designate identical elements that are common to the figures. It is contemplated that some elements of one embodiment may be beneficially incorporated in other embodiments.

### DETAILED DESCRIPTION

Embodiments of the invention provide an ESD protection device that provides minimal impact on the spatial limitations imposed by general circuit design as well as reducing or eliminating the likelihood of parasitic capacitance and current leakage caused by introduction of an ESD at the point of protection. These advantages are realized by first approaching the ESD protection device as two separate parts and then by strategically locating each of these parts to achieve the desired results. The details of this approach and the overall advantages are provided in the following description and accompanying drawings.

FIG. 2 depicts a block diagram of an ESD protection circuit (ESDPC) 200 in accordance with the subject invention. The ESDPC 200 includes a shunt subcircuit 202 and a trigger subcircuit 204. The trigger subcircuit 204 determines when the shunt subcircuit 202 should become operative (i.e. become low resistive) and the shunt subcircuit 202 performs the actual operation of circuit protection by shunting current generated by an ESD event to, for example, ground. As can be seen by inspection of FIG. 2, the shunt subcircuit 202 and the trigger subcircuit 204 are connected at different nodes. The trigger subcircuit 204 is connected between a first voltage reference potential 206 at node Nth and a second voltage reference potential 216 at node Ntl. The shunt subcircuit 202 is connected between a local/signal pin 110 (i.e., a pad of an IC connection or other similar device requiring ESD protection) at node Neh and a second signal pin 208 (node Neh). Thus, the invention is directed to triggering a local shunt, through a trigger path that is not connected to a local pin, but rather to a source of reference potential (e.g., VSS, VDD, Vref). It is assumed that an ESD event will occur on the reference potential pins or pads and can be used to trigger the shunt subcircuit to shunt the ESD event away from the critical circuitry connected to either input pad 110 or 208 being protected.

The ESD event on pad 110 is coupled to Ntl through 214 or to Nth through pad 212. As shall be described below, the current path 214 or 212 may be a short connection between the trigger subcircuit 204 and the shunt subcircuit 202 can be explicitly added as path 210 or can be an intrinsic path within the shunt subcircuit 202.

In operation, when a locally applied ESD event occurs, a trigger current flows between the two sources of reference potential 206 and 216 respectively through the conductive circuit 212. Such action then triggers local protection between the local/signal pad 110 and a source of reference potential 216. The triggering action is accomplished via a shunt subcircuit 202 activation signal sent along an output 210 of the trigger subcircuit 204. Thus, in one embodiment of the invention, a single trigger subcircuit 204 is coupled between the power terminals VDD and VSS of an IC and individual shunt subcircuits 202 are coupled to each input signal pad of the IC. The single trigger subcircuit 204 activates all of the individual shunt circuits 202 when an ESD event is sensed between the terminals 206 and 216.

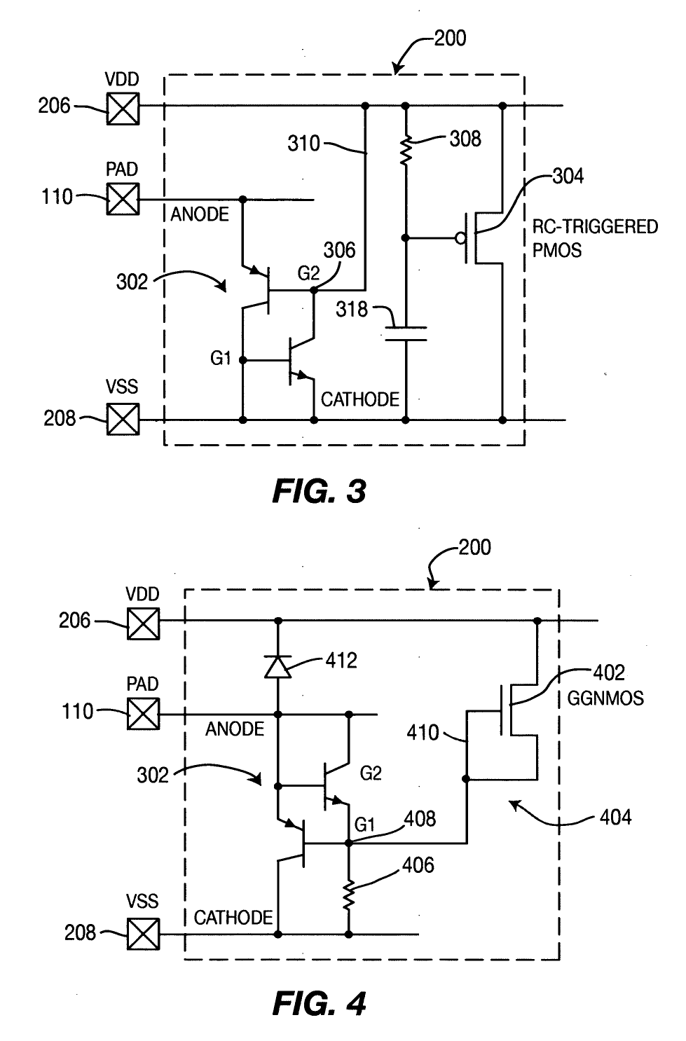

FIG. 3 depicts a circuit diagram of a first embodiment of the invention, an ESDPC 200, as presented in FIG. 2. In this embodiment, implementation of the shunt subcircuit is accomplished by a silicon-controlled rectifier (SCR) 302. The SCR 302 is coupled between pad 110 (PAD=SCR Anode=Neh) and second voltage reference potential (VSS) 208 (SCR Cathode/G1=VSS=Nel). In this embodiment, current path 214 is a short that connects node 208 to node 216. A first base/collector node (G2) 306 is coupled to first voltage reference potential VDD. To trigger the SCR 302, a trigger circuit is added between VDD (Nth) and VSS (NtI). In one embodiment of the invention, the trigger circuit 204 of FIG. 2 is a PMOS 304 triggered by an RC circuit 308/310 connected thereto. Connection 310 between node 306 (G2) and VDD pad 206 acts as both a trigger connection 210 (FIG. 2) and conductive path between Neh and Nth (path 212 in FIG. 2).

In operation, a first current will flow from pad 110 through the Anode-G2 diode of the SCR 302 to VDD (which is floating at the time of ESD). Between first voltage reference potential (VDD) 206 and second voltage reference potential (VSS) 208, the PMOS trigger circuit 304 draws current, as long as the capacitance of the RC-PMOS is not charged up. Since this current flows through the Anode-G2 diode of the SCR 302, the SCR 302 will trigger, shunting ESD current away from the pad 110 (and any IC pins/devices connected thereto). The time constant of the PMOS is small (approximately 5 to 30 ns, depending on the triggering speed of the SCR) since the trigger circuit only needs to work during the turn-on time of the SCR 302. Note that if there is an alternate current path between first voltage reference potential (VDD) 206 and pad 110 (e.g., a PMOS output driver), the RC-PMOS is set to sustain relatively higher current levels (on the order of approximately a few 100 mA). This is necessary since not all current through the trigger circuit is used to trigger the SCR 302.

The advantage of this first embodiment over existing local clamps is as follows:
(1) the trigger circuit can be shared over multiple IO cells; thus, saving area by avoiding duplication of parts;
(2) no trigger circuit is added to the pad; thus, no parasitic capacitance or additional noise is added to a device connected thereto; and
(3) no trigger circuit is added to the pad; thus, there is less leakage current between pad 110 and second voltage reference potential.

FIG. 4 depicts a circuit diagram of a second embodiment of the invention, an ESDPC 200, as presented in FIG. 2. In this embodiment, implementation of the shunt subcircuit is again accomplished by an SCR 302. The SCR 302 is coupled between pad 110 and VSS (Anode/G2 coupled to PAD, Cathode coupled to VSS). A trigger circuit 404 is constructed between first voltage reference potential VDD 206 and second voltage reference potential VSS 208 as in the previous embodiments. However, trigger circuit 404 includes a GGNMOS 402 with a series resistor 406. A node 408 between the GGNMOS 402 and series resistor 406 is coupled to the G1 node (through path 410) of the SCR 302 to trigger the SCR 302 during ESD operation. Additionally, a diode 412 is connected between pad 110 and first voltage reference potential VDD 206. To reduce capacitance at the pad 110, the G2 node of the SCR 302 can be optionally coupled to first voltage reference potential VDD 206.

When an ESD event arrives at the pad 110, a first current will flow through the diode 412 to first voltage reference potential VDD 206 and then through the trigger circuit 404. In response, the GGNMOS 402 will go into NPN mode, thereby raising the potential at the G1 node 408. Raising this potential forward biases the G1-Cathode “intrinsic diode” of the SCR 302, thereby triggering the SCR 302. The ESD current will then be shunted by the SCR 302. In addition to advantages (1), (3) and (4) presented above, an advantage of this design is that in all cases all the current through the trigger circuit 404 is used to trigger the SCR 302. Note that although the GGNMOS 402 functions to trigger the SCR 302, in some cases this transistor can have normal operation functionality, with the gate coupled to an internal node. In this case, the series resistor 406 must be carefully chosen as not to trigger the SCR 302 during normal operation.

While the foregoing is directed to embodiments of the present invention, other and further embodiments of the invention may be devised without departing from the basic scope thereof, and the scope thereof is determined by the claims that follow.

What is claimed is:

1. An apparatus for ESD circuit protection comprising:
a trigger subcircuit coupled between a first voltage reference potential and second voltage reference potential, where the trigger subcircuit comprises an active circuit; and
at least one ESD shunt subcircuit coupled to the trigger subcircuit and coupled between a circuit device to be ESD-protected and the second voltage reference potential.

2. The apparatus of claim 1, wherein the at least one ESD shunt subcircuit is coupled to a circuit device to be ESD-protected via a pad of an integrated circuit (IC) connection.

3. The apparatus of claim 1, wherein the trigger subcircuit sends a trigger signal to the at least one ESD shunt subcircuit when an ESD event occurs.

4. The apparatus of claim 1, wherein the at least one ESD shunt subcircuit is a silicon-controlled rectifier (SCR).

5. The apparatus of claim 4, wherein an anode of the SCR is connected to the circuit device to be ESD-protected.

6. The apparatus of claim 4, wherein a cathode of the SCR is connected to the second voltage reference potential.

7. The apparatus of claim 4 wherein a first base/collector node of the SCR is connected to the first voltage reference potential.

8. The apparatus of claim 1, wherein the trigger subcircuit is an RC-triggered MOS.

9. The apparatus of claim 8, wherein a time constant of the RC portion of the trigger subcircuit is approximately 5 to 30 ns.

10. The apparatus of claim 1, wherein the trigger subcircuit is a GGNMOS transistor.

11. The apparatus of claim 10, further comprising a diode connected between circuit device to be ESD-protected and the first voltage reference potential.

12. The apparatus of claim 10, wherein a first node of the SCR is coupled to the first voltage reference potential to reduce capacitance at the circuit device to be ESD-protected.

13. The apparatus of claim 10 wherein the shunt subcircuit is an SCR comprising a G1 node and the GGNMOS transistor is coupled to the G1 node.

14. The apparatus of claim 1 wherein the at least one shunt subcircuit comprises a plurality of shunt subcircuits that are each coupled to a separate circuit to be protected, and a trigger subcircuit is coupled to each of the shunt subcircuits in the plurality of shunt subcircuits.

15. A method of protecting circuitry from an electrostatic discharge (ESD) event comprising:
sensing an ESD event occurrence at a remote location from a pad to be protected;
shunting the ESD event from the pad to be protected upon sensing the ESD event.

16. The method of claim 15 wherein the shunting step further comprises activating a silicon controlled rectifier.

17. The method of claim 15 wherein the remote location is between a first voltage reference potential and a second voltage reference potential.

18. The method of claim 15 wherein the sensing step is performed for a single remote location and the shunting step is performed for a plurality of pads to be protected when an ESD event is sensed at the single remote location.

19. The method of claim 18 where the single remote location is between the power input terminals for an integrated circuit.
